(19) United States
(12) Patent Application Publication
(10) Pub. No.: US 2019/0240609 A1
(43) Pub. Date: Aug. 8, 2019

(54) PROJECTION DISPLAY DEVICE AND FILTER STRUCTURAL BODY

(71) Applicant: SONY CORPORATION, TOKYO (JP)

(72) Inventors: TAKEAKI HIRASAWA, TOKYO (JP); YOSHIMASA GOSHIMA, KANAGAWA (JP)

(21) Appl. No.: 16/318,742

(22) PCT Filed: May 26, 2017
(86) PCT No.: PCT/JP2017/019653

§ 371 Date: Jan. 18, 2019

(30) Foreign Application Priority Data
Aug. 1, 2016 (JP) 2016-151270

(51) Int. Cl. B01D 46/52; B01D 46/00; G03B 21/16

(52) U.S. Cl. CPC B01D 46/522; B01D 46/0023; G03B 33/12; B01D 2279/45; G03B 21/16

(57) ABSTRACT

[Object] To propose a projection display device that includes a filter structural body that is excellent in pressure-loss recoverability and can be miniaturized.

[Solution] There is provided a projection display device, including: a filter structural body in which a plurality of filters each including a folding structure in which a concavity-convexity is repeated are stacked. In the filter structural body, respective convex portions of the filters are made to coincide, and between a pitch of any of the filters, one concave portion or a plurality of concave portions of another filter is or are accommodated, and in an inside of the filter having a maximum length in a vertical direction relative to a filter surface, another filter is accommodated.

### TECHNICAL FIELD

The present disclosure relates to a projection display device and a filter structural body.

### BACKGROUND ART

In a projector being a projection display device that displays an image by projecting the image onto a screen or the like, in order to suppress a temperature rise in the inside of the projector due to heat generation of a light source, a power source, or the like and to prevent failure of devices and deterioration of optical parts, a cooling fan is disposed. By taking the outside air into the inside of the projector with the cooling fan, the inside of the projector is cooled. At this time, in order to prevent invasion of dust into the inside of the projector, a filter is disposed at an air intake port of the projector.

In order to lower pressure loss, a filter is constituted such that its surface area becomes large. For example, in Patent Literature 1, a pleat-shaped (zigzag shape in which mountain and valley are repeated) filter is disclosed. As the pleat is made deeper, the surface area becomes larger, and an area capable of allowing the outside air to pass through, increases, which results in that pressure loss lowers.

### CITATION LIST

### Patent Literature

Patent Literature 1: JP 2012-76015A

Patent Literature 2: JP 2010-197575A

### DISCLOSURE OF INVENTION

### Technical Problem

However, in a portion of the pleat where the depth of a concavity-convexity is deeper, trash and the like in which dust has been collected gets clogged. It is hard to remove the dust having got clogged in the portion where the depth of the concavity-convexity is deeper. For this reason, as compared with a filter in which the depth of the concavity-convexity is shallow, a filter in which the depth of the concavity-convexity is deeper, can lower pressure loss. However, since the removability of dust becomes low, the so-called pressure-loss recoverability that lowers again the increased pressure loss due to clogging of dust by removing the clogging, is low.

As an example of using by stacking pleat-shaped filters in multiple stages, for example, in Patent Literature 1, a constitution of a dust collecting filter made in a two-layer structure of a main filter and a sub-filter, is disclosed. However, in Patent Literature 1, it is only that the respective filters are merely stacked. Accordingly, a space corresponding to the sum of the depths of the respective pleats becomes necessary. For this reason, it has impeded the miniaturization of the device that uses the filter.

Then, in the present disclosure, a novel and improved filter structural body that is excellent in pressure-loss recoverability and can be miniaturized, and a projection display device that includes this, are proposed.

### Solution to Problem

According to the present disclosure, there is provided a projection display device, including: a filter structural body in which a plurality of filters each including a folding structure in which a concavity-convexity is repeated are stacked. In the filter structural body, respective convex portions of the filters are made to coincide, and between a pitch of any of the filters, one concave portion or a plurality of concave portions of another filter is or are accommodated, and in an inside of the filter having a maximum length in a vertical direction relative to a filter surface, another filter is accommodated.

In addition, according to the present disclosure, there is provided a filter structural body, including: a plurality of filters each including a folding structure in which a concavity-convexity is repeated. Respective convex portions of the filters are made to coincide, and between a pitch of any of the filters, one concave portion or a plurality of concave portions of another filter is or are accommodated, and in an inside of the filter having a maximum length in a vertical direction relative to a filter surface, another filter is stacked so as to be accommodated.

### Advantageous Effects of Invention

As described in the above, according to the present disclosure, it is excellent in pressure-loss recoverability, and it becomes possible to miniaturize. Note that the effects described above are not necessarily limitative. With or in the place of the above effects, there may be achieved any one of the effects described in this specification or other effects that may be grasped from this specification.

### BRIEF DESCRIPTION OF DRAWINGS

FIG. 1 is a schematic illustration showing a schematic constitution of a projection display device including a filter structural body according to the first embodiment of the present disclosure.

FIG. 2 is a perspective view showing an external appearance of a filter structural body according to the same embodiment, and shows a state where an upper portion side has been cut out.

FIG. 3 is a perspective view showing a state where the filter structural body according to the same embodiment is seen from a first filter side.

FIG. 4 is a perspective view showing a state where the filter structural body according to the same embodiment is seen from a second filter side

FIG. 5 is a partial plan view for describing a configuration of a filter section according to the same embodiment.

FIG. 6 is an explanatory illustration for describing a removability of dust in the case where the depth of a filter is shallow.

FIG. 7 is an explanatory illustration for describing a removability of dust in the case where the depth of a filter is deeper.

FIG. 8 is an explanatory illustration for describing a constitution of a filer section according to the same embodiment and its action.

FIG. 9 is an explanatory illustration for showing one example of a fixing method of a first filter and a second filter.

FIG. 10 is a perspective view showing a state where a first filter section and a second filter section are disassembled and a state where these filters are combined, with regard to a filter structural body according to the second embodiment of the present disclosure.

FIG. 11 is a partially-enlarged top view for describing a stacking state of a filter structural body according to the same embodiment, and is an enlarged view of a region A in FIG. 10.

FIG. 12 is an explanatory illustration showing one modified example of a filter section of a filter structural body of the present disclosure.

FIG. 13 is an explanatory illustration showing other modified example of a filter section of a filter structural body of the present disclosure.

### MODE(S) FOR CARRYING OUT THE INVENTION

Hereinafter, (a) preferred embodiment(s) of the present disclosure will be described in detail with reference to the appended drawings. Note that, in this specification and the appended drawings, structural elements that have substantially the same function and structure are denoted with the same reference numerals, and repeated explanation of these structural elements is omitted.

It should be noted that description is given in the following order.

1. First embodiment (in case of one frame)

1.1. Schematic constitution of projection display device

1.2. Filter Structural body
(1) Constitution
(2) Action of filter section

2. Second embodiment (in case of including plurality of frames)

3. Modified example

### 1. First Embodiment

[1.1. Schematic Constitution of Projection Display Device]

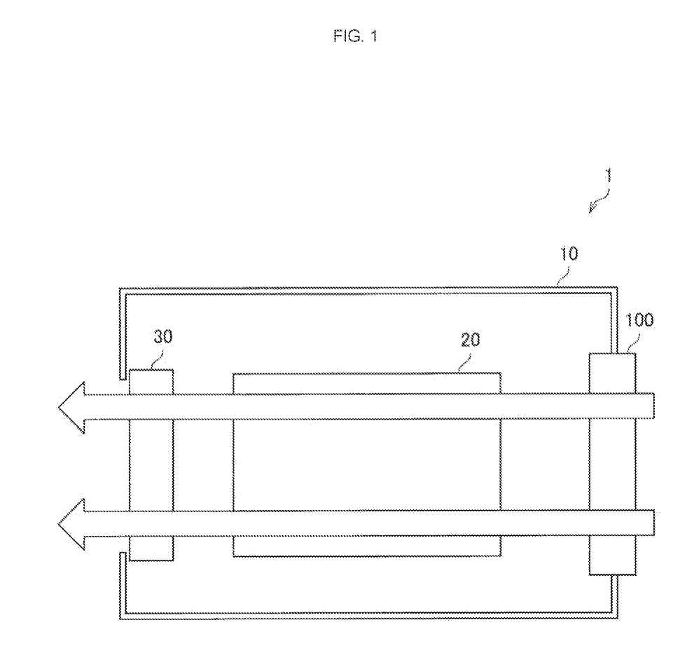

First, with reference to FIG. 1, description is given for a schematic constitution of a projection display device including a filter structural body according to the first embodiment of the present disclosure. FIG. 1 is a schematic illustration showing a schematic constitution of a projection display device including a filter structural body according to the present embodiment.

A projection display device 1 is, for example, a projector that displays an image by projecting the image on a screen or the like. The display system of the projection display device 1 according to the present embodiment is not limited specifically, and for example, supposed are projectors of various systems, such as a 3LCD (Liquid Crystal Display) system, a DLP system, and a LCOS (Liquid Crystal On Silicon) system. For example, in the projector of the 3LCD system, white light emitted from a light source device serving as a light source section is separated into three primary colors of red, green, and blue, and the separated three color light rays are made to transmit the respective three LCDs, thereby generating an image to be projected onto a display surface such as a screen. The projector of the 3LCD system includes, for example, constituent parts of an optical modulation synthesis system for synthesizing incident light by modulating the incident light, such as a liquid crystal panel and a dichroic prism; constituent parts of a illumination optical system for guiding light from a light source device to a liquid crystal panel, such as a reflective dichroic mirror and a reflective mirror; and constituent parts of a projection optical system for projecting an image emitted from a dichroic prism. In FIG. 1, a power supply board, a signal processing board, and these parts of the projector including a light source are shown as a constituent part 20.

In the projection display device 1 according to the present embodiment, as shown in FIG. 1, the constituent part 20 is disposed in a housing 10, and an image generated by the constituent part 20 is output from the housing 10 through a lens to a projection plane. In the projection display device 1, in order to suppress a temperature rise in the inside of the housing 10 due to heat generation of a light source, a power source, or the like and to prevent failure of devices and deterioration of optical parts, a cooling fan 30 is disposed. The outside air is taken into the inside of the housing 10 by the cooling fan 30. At this time, in order to prevent invasion of dust into the inside of the housing 10, a filter structural body 100 is disposed at an air intake port of the housing 10. In this connection, FIG. 1 is the schematic diagram. Accordingly, in addition to the filter structural body 100 shown in FIG. 1, a fan may be installed at other opening (not shown) of the housing 10, it may be constituted to assist exhausting the inside of the housing 10.

The filter structural body 100 of the projection display device 1 according to the present embodiment is a multistage filter constituted by stacking a plurality of filters. Here, the filter structural body 100 is constituted to be excellent in pressure loss and to be able to be miniaturized. Namely, it is constituted that pressure loss is low, and that, also when dust has got clogged, it is possible to remove the dust easily. Moreover, the respective filters are stacked such that the depth (depth of a concavity-convexity) of the filter structural body 100 does not become large, whereby the filter structural body 100 can be miniaturized. With this, the size of the projection display device itself can be miniaturized. Hereinafter, a constitution of the filter structural body 100 according to the present embodiment and its action will be described in detail.

[1.2. Filter Structural Body]

(1) Constitution

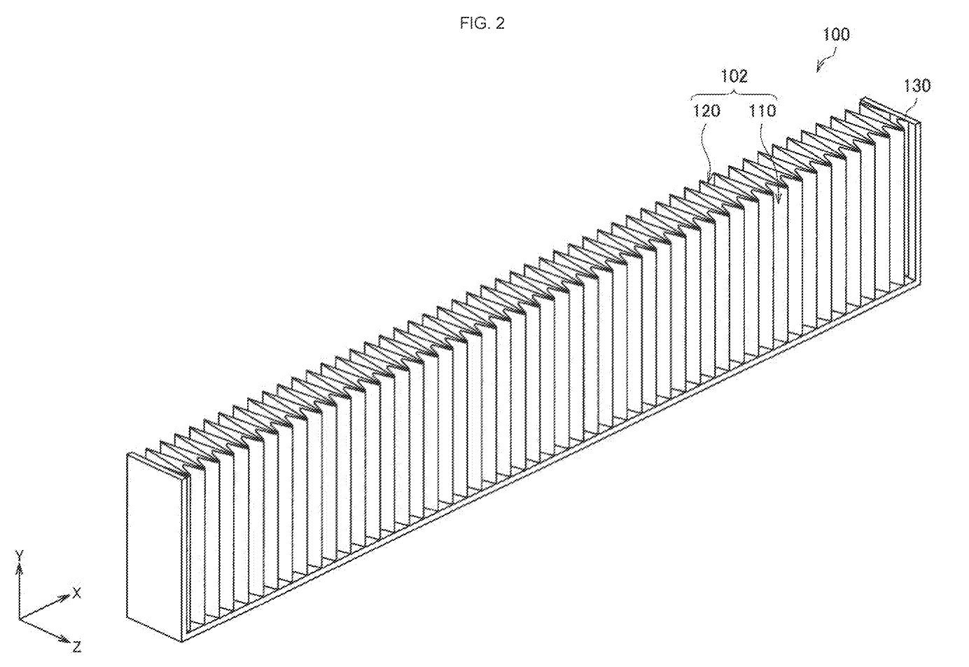

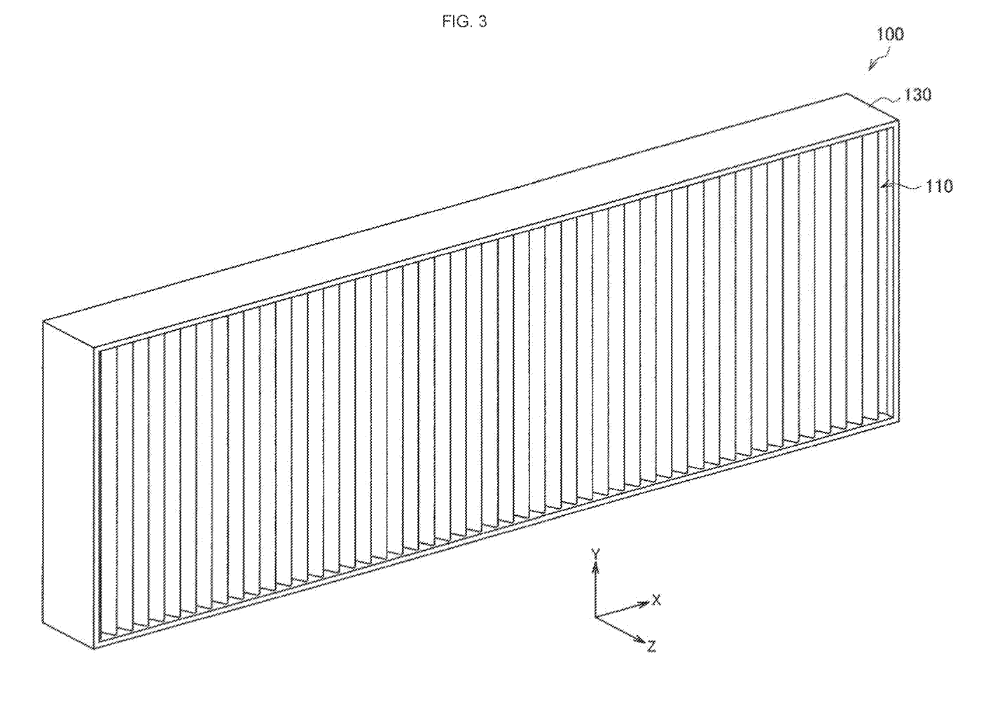

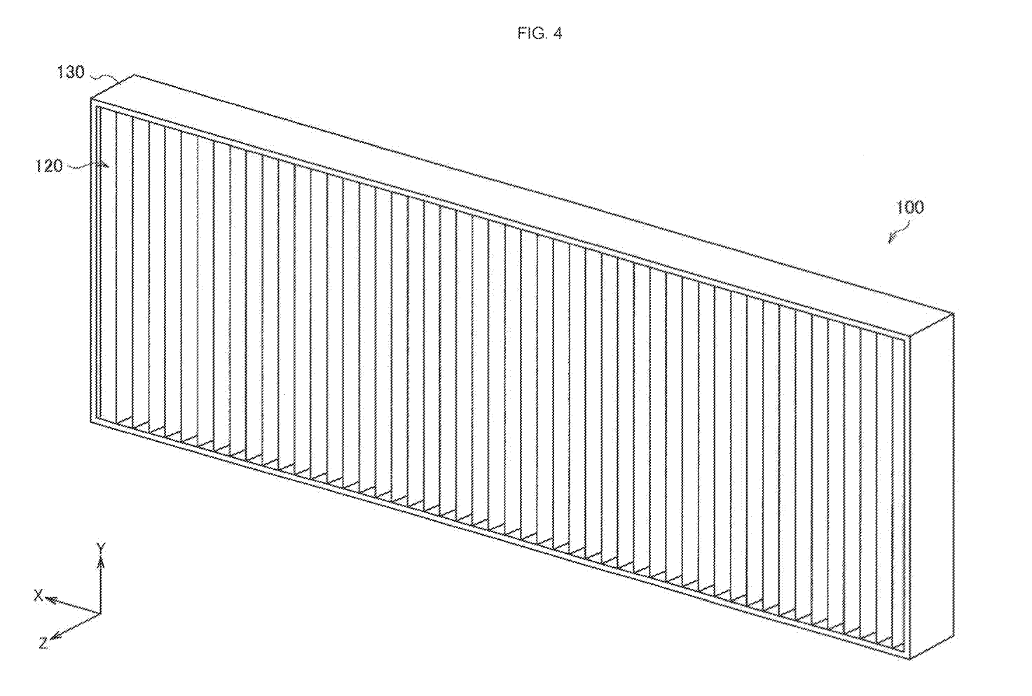

In FIG. 2 through FIG. 5, an external appearance of the filter structural body 100 according to the present embodiment is shown. FIG. 2 is a perspective view showing an external appearance of the filter structural body 100 according to the present embodiment, and shows a state where an upper portion side has been cut out. FIG. 3 is a perspective view showing a state where the filter structural body 100 according to the present embodiment is seen from a first filter 110 side. FIG. 4 is a perspective view showing a state where the filter structural body 100 according to the present embodiment is seen from a second filter 120 side. FIG. 5 is a partial plan view for describing a configuration of a filter section 102 according to the present embodiment.

As shown in FIG. 2, the filter structural body 100 according to the present embodiment includes the filter section 102 including a plurality of filters 110 and 120 and a frame section 130 to which the filter section 102 is fixed. In the present embodiment, description is given for a case where the filter section 102 includes two filters of the first filter 110 and the second filter 120. However, the present disclosure is not limited to such an example, three or more filters may be stacked.

As shown in FIG. 2 through FIG. 4, the first filter 110 and second filter 120 are a filter with a folding structure in which a convex portion 115 or 125 and a concave portion 117 or 127 are repeated. As shown in FIG. 2, the first filter 110 and the second filter 120 are stacked in the direction (the Z direction) vertical to the filter plane. The first filter 110 has the depth (depth of a concavity-convexity) of a filter lower than that of the second filter 120, and a concavity and a convexity of the first filter 110 are accommodated between a concavity and a convexity of the second filter 120. At this time, the convex portion 115 of the first filter 110 and the convex portion 125 of the second filter 120 are made to coincide with each other, whereby the first filter can be accommodated within the height of the second filter 120. With this, the space saving of the filter section 102 is realized.

The first filter 110 is a former-stage filter disposed on the external-portion side in the housing 10, and is a portion through which gas to be taken into the inside of the housing 10 passes first. As the first filter 110 to be disposed at the former stage, proper is a low pressure loss filter that is formed from a material from which dust adhered to the filter drops off easily. Moreover, it may be sufficient that the first filter 110 is able to roughly collect dust of a comparatively large size. For example, it may be sufficient that the first filter 110 is able to remove dust of a size of about 8 μm with a collection efficiency of about 70% or more. As the material of the filter having such characteristics, for example, there is an electretized spunbond nonwoven fabric, a general-purpose decorative nonwoven fabric, or the like.

The second filter 120 is a latter-stage filter disposed in the inner side in the housing 10 than the first filter 110, and is a portion through which the gas having passed through the first filter 110 passes next. As the second filter 120 to be disposed at the latter stage, a filter of high collection efficiency and low pressure loss is proper. Since the second filter 120 is a filter that removes dust having been not removed by the first filter 110, high collection efficiency is requested than easiness in removal of dust adhered to the filter. As the material of the filter having such characteristics, for example, there is an electretized film split fiber nonwoven fabric, an electretized needle punch nonwoven fabrics, or the like.

Here, in the case of using an electret type filter that collects dust by utilizing an electrostatic force generated by the electrostatic charge of the filter, like the electretized spunbond nonwoven fabric, the electretized film split fiber nonwoven fabric, or the electretized needle punch nonwoven fabrics, collection efficiency can be raised while reducing the pressure loss of the filter. Such an electret type filter can be used for both the first filter 110 and the second filter 120 as mentioned in the above.

On the other hand, the electret type filter is usually white, and it is difficult to improve decorativeness by performing any coloring. However, according to the constitution of the filter section 102 according to the present embodiment, even if the first filter 110 at the former stage allows dust with a small particle size to pass through, since it is possible to collect the dust by the second filter 120 at the latter stage, a filter of high collection efficiency like the electret type may be not used. Therefore, even if the collection efficiency is not high, it is possible to use nonwoven fabric with high decorativeness. There may be a case where the first filter 110 is installed at a position that exposes to the outside of the housing 10 and that is visible to a user. Accordingly, for example, it also becomes possible to select its color so as to match the color of the housing 10.

In this way, by making the former-stage filter and the latter-stage filter constituting the filter section 102 have the respective characteristics proper for them respectively, in the case of combining them, it is possible to constitute the filter section 102 of low pressure loss and high collection efficiency.

Moreover, dimensions with regard to the first filter 110 and the second filter 120 are not limited specifically. However, in consideration of the dust removability of the filter, the folding angle of the filter may be set. As shown in FIG. 5, the folding angle of the filter means the opening angle of a concave portion specified by the concave portion disposed between adjacent convex portions of the filter, and it is assumed that the folding angle of the first filter 110 is θ₁ and the folding angle of the second filter 120 is θ₂. In this connection, it is assumed that the height of the first filter 110 is Z₁ and the depth of the second filter 120 is Z₂. Moreover, it is assumed that a distance (i.e., the pitch of the first filter 110) between the adjacent convex portions 115 of the first filter 110 is W1, and a distance (i.e., the pitch of the second filter 120) between the adjacent convex portions 125 of the second filter 120 is W2.

In the present embodiment, since it is sufficient that at least the dust removability of the former-stage filter is high, it may be sufficient that the folding angle θ₁ of the first filter 110 is an angle at which it is easy to remove dust. In concrete terms, it is preferable that the folding angle θ₁ is 30 degrees or more, and it is more preferable that it is 45 degrees or more. For example, it is assumed that each of the pitch W₁ of the first filter 110 and the pitch W₂ of the second filter 120 has been made 5 mm, that the depth Z₁ of the first filter 110 has been made 5 mm, and that the depth Z₂ of the second filter 120 has been made 23 mm. In this case, the folding angle θ₁ of the first filter 110 becomes 53.1 degrees, and the folding angle θ₂ of the second filter 120 becomes 12.4 degrees. At this time, in the first filter 110, by adding a shock lightly to dust, the dust has been able to be made to fall easily from the filter. However, in the second filter 120, it has been difficult to remove dust from the filter. Moreover, in the case where the depth Z₁ of the first filter 110 is changed to 10 mm, the folding angle θ₁ becomes 28 degrees. In the filters at this time, from the second filter 120 with the folding angle θ₂ of 12.4 degrees, dust has been able to be removed easily. However, there has not been removal easiness similar to that in the case of the folding angle θ₁ of 53.1 degrees. With this, it is preferable that the folding angle θ₁ is 30 degrees or more, and it is more preferable that it is 45 degrees or more.

In this connection, the depth of the filter section 102 is dependent on a filter having the maximum depth among the filters constituting the filter section 102. Therefore, in consideration of not increasing pressure loss more than a predetermined value, the depth of the filter section 102 may be set as low as possible.

(2) Action of Filter Section

Generally, in the case of continuing to use a filter, dust has been adhering gradually to the filter, and the filter has been getting clogged gradually. With this, pressure loss increases, and the air quantity at the time of being taken into the inside of the housing 10 also lowers. For this reason, it is necessary to perform exchanging the filter or removing dust from the filter at a predetermined frequency. As a method of removing dust, for example, there are a method in which a filter is detached from a housing and applied with a shock from the outside, a method in which an automatic removal mechanism to remove dust from a filter automatically is installed to a device (for example, the above-described Patent Literature 2), and so on. On the other hand, with regard to the configuration of a filter, the surface area of a filter in the case of being provided with a concavity-convexity becomes larger than that in the case of being made a simple flat surface. Accordingly, in the case of obtaining the same air quantity, passing air quantity per unit area of a filter in the case of being provided with a concavity-convexity becomes smaller. That is, by making a filter have a folding structure, it is possible to lower the wind speed of air passing the filter. Generally, as a wind speed in a filter is larger, the pressure loss by the filter becomes larger. Accordingly, as a wind speed is smaller, the pressure loss becomes smaller. Therefore, by making the surface area larger by making the depth of a concavity-convexity of the filter deeper, it is possible to make pressure loss by the filter smaller.

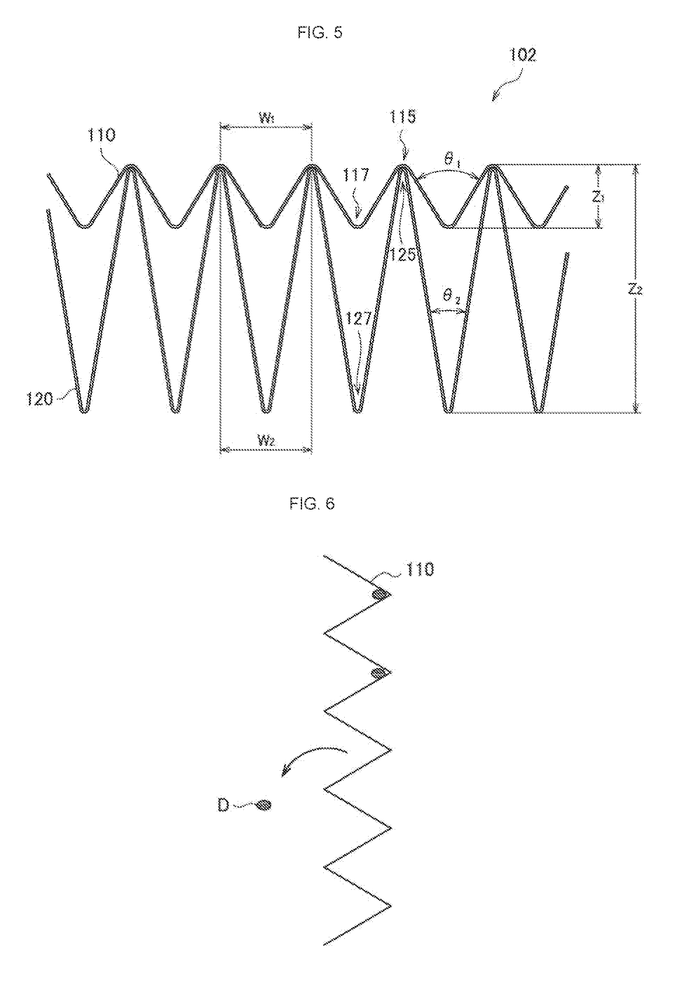

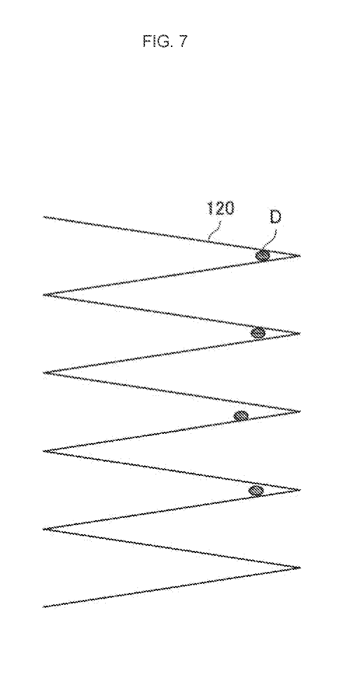

However, as mentioned in the above, the removability of dust is different depending on the depth of a filter. For example, in the case of the same pitch, in the case where the depth of a filter is shallow, as shown in FIG. 6, a folding angle becomes larger. Accordingly, dust D falls from the filter easily by a shock. On the other hand, in the case where the depth of a filter becomes large, as shown in FIG. 7, a folding angle becomes small. At this time, in the case where dust D collected by a filter has stayed at a position deeper in the inside of the filter, even if a shock is given from the outside or the automatic removal mechanism of dust is used, it is difficult to make the dust fall from the filter. That is, the performance recoverability for obtaining the original low pressure loss and dust removability by removing dust at the time of the maintenance of the filter, is lowered.

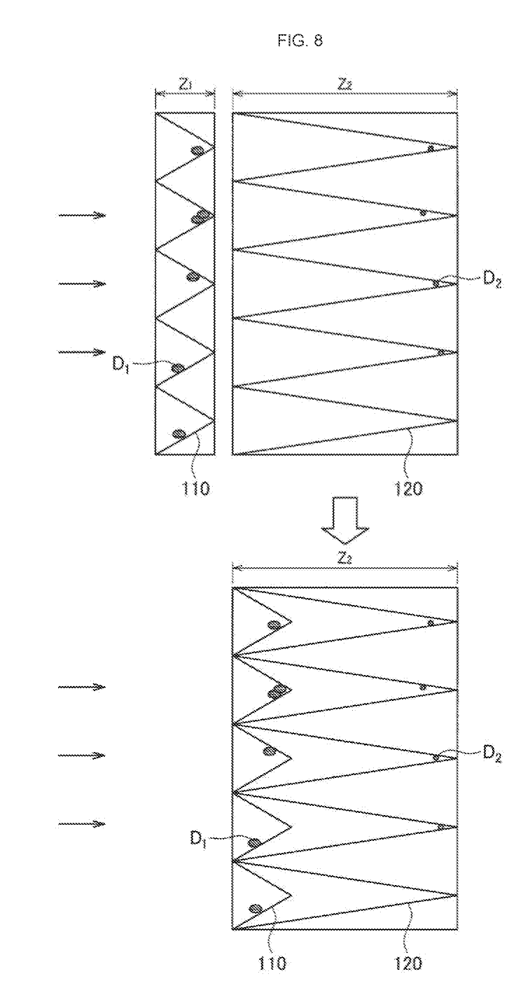

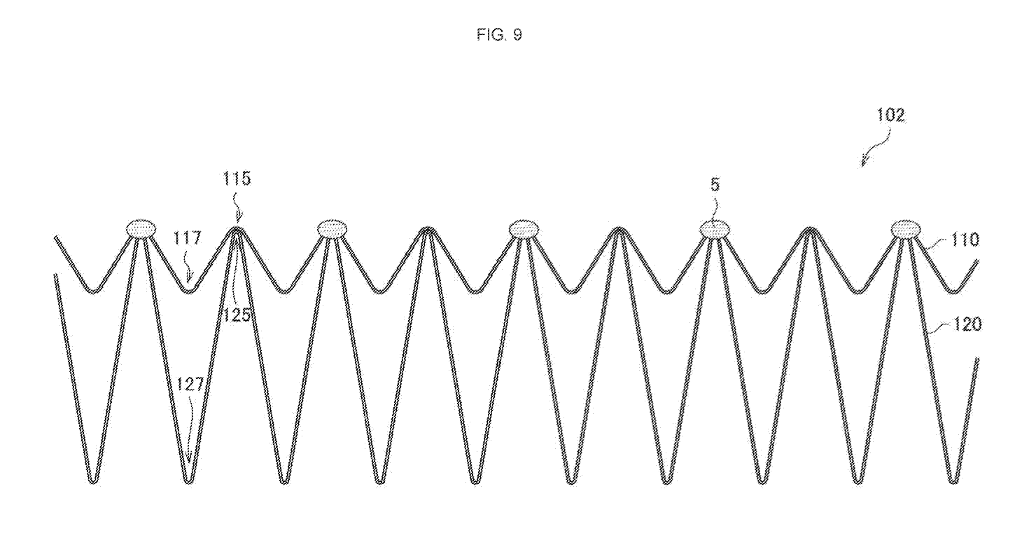

Then, in the present embodiment, by arranging filters in multi-stages in the filter section 102 as mentioned in the above, the performance recoverability of the filter is maintained. In FIG. 8, the outline of a constitution of the filter section 102 according to the present embodiment is shown. As shown in FIG. 8, the filter section 102 according to the present embodiment includes the first filter 110 at the former stage and the second filter 120 at the latter stage. The first filter 110 with the shallow depth is disposed at the former stage of the second filter 120 at the latter stage with the deeper depth, and dust is collected to some extent by the first filter 110 so that the amount of adhesion of dust to the second filter 120 is reduced. At this time, since the depth of the first filter 110 is shallow, in the case of using a filter with a large weight per unit area (fine filter), pressure loss becomes large. Therefore, it is preferable that a filer with a small weight per unit area (coarse filter) as compared with the second filter 120 is used as the first filter 110.

On the other hand, in a coarse filter with a small weight per unit area, the collection performance of dust of a fine particle size gets lowered. Accordingly, the first filter 110 may sometimes pass the dust of a small particle size to the second filter 120 side. However, it is possible for the first filter 110 to collect dust of a large size that tends to easily cause clogging. Moreover, since the depth of a concavity-convexity in the first filter 110 is shallow, it is easy to remove dust. Therefore, as shown at the upper side in FIG. 8, comparatively large dust D₁ is collected by the first filter 110, and fine dust D₂ having been not collected by the first filter 110 is removed by the second filter 120, whereby it is possible to constitute a filter that is excellent in the removability of dust and has high filter-performance recoverability.

Moreover, as shown at the lower side in FIG. 8, in the filter section 102 according to the present embodiment, the convex portion 115 of the first filter 110 and the convex portion 125 of the second filter 120 are made to coincide with each other, and the first filter 110 is accommodated within the second filter 120 with the deeper depth. With this, as shown at the lower side in FIG. 8, the depth of the whole filter section 102 becomes the same as the depth Z₂ of the second filter 120, whereby it becomes possible to achieve the space saving in the filter structural body 100. Moreover, such a filter structural body 100 can realize the performance equivalent to that in the case where the first filter 110 and the second filter 120 have been arranged separately so as not to overlap with each other in the stacked direction as shown at the upper side in FIG. 8. Accordingly, it is possible to increase the collection efficiency of dust more than the case of the second filter 120 alone.

Moreover, the convex portion 115 of the first filter 110 and the convex portion 125 of the second filter 120 are made to coincide with each other so as to bring a plurality of filters in a state of being co-folded, whereby it is possible to increase the strength of the filter itself. With this, it is possible to prevent the pleats of the filter from getting twisted. In the case where the pleats of the filter get twisted and become an uneven state, the pressure loss of the filter increases. Then, by increasing the strength of the filter, it is possible to suppress the increasing of pressure loss. Furthermore, by increasing the strength of the filter, at the time of removing dust adhering to the filter by adding a shock to the frame section 130 from the outside, it is possible to propagate the shock efficiently to the whole filter. In the case where the strength of the filter is low, a shock given from the outside is absorbed by the flexibility of the filter, whereby a shock enough to make dust fall is not propagated to an adhering portion of dust so that there may be a case where dust cannot be removed sufficiently. Therefore, a plurality of filters are stacked so as to be made a state of being co-folded, whereby the strength of the filter is made to increase, and it becomes possible to remove dust efficiently.

Furthermore, since it becomes also possible to fix the first filter 110 and the second filter 120 to one common frame, it becomes possible to contribute reducing of the number of parts and cost reduction. The filter is usually fixed with a binding material etc. to the frame section 130 surrounding the outer periphery of the filter section 102. The fixing of the filter section 102 and the frame section 130 is performed not only for fixing the filter section 102 physically, but also for preventing dust from invading into the inside of the housing 10 from a gap between the filter section 102 and the frame section 130. In the filter section 102 according to the present embodiment, it is sufficient that at least any one of the first filter 110 and the second filter 120 is fixed to the frame section 130, and the other filter may be not necessarily fixed to the frame section 130.

For example, as shown in FIG. 9, in the contact point between the first filter 110 and the second filter 120, i.e., in the vertex of each of the convex portions 115 and 125, the first filter 110 and the second filter 120 may be fixed with an adhesive 5 or the like. In this way, the filters are fixed to each other within the filter surfaces, whereby it is also possible to increase the rigidity of the filter section 102. With regard to the fixing between filters, it is not necessary to fix all the contact points. As shown in FIG. 9, for example, the vertices of the convex portions 115 and 125 may be fixed every two vertices. With this, it is possible to reduce the used amount of the adhesive, and it is possible to realize cost reduction and easiness in bonding work.

In the above, the filter structural body 100 according to the first embodiment of the present disclosure has been described. According to the filter structural body 100 according to the present embodiment, it is a multistage filter in which the first filter 110 and the second filter 120 each including a folding structure in which a concavity-convexity is repeated, are stacked, convex portions 115 and 125 of the respective filters 110 and 120 are made to coincide with each other, and one concave portion 117 or a plurality of concave portions 117 of the first filter 110 at the former stage is or are accommodated between a pitch of the second filter 120 at the latter stage. At this time, in the direction vertical to the filter surface, the first filter 110 is accommodated in the inside of the second filter 120 with the deeper depth.

It is possible to make pressure loss low by making the surface area of each filter larger, and since the depth of the concavity-convexity of the first filter 110 at the former stage is shallow, when dust has got clogged, it is possible to remove the dust easily. Furthermore, the respective filters are stacked such that the depth (depth of a concavity-convexity) of the filter section 102 does not become large, whereby the filter structural body 100 is made a small size. With this, it is possible to make the size of the projection display device 1 itself small. By using such a filter structural body 100, it is possible to prevent a temperature rise in the inside of the housing 10 of the projection display device 1, and it is possible to maintain the performance of the projection display device 1 satisfactorily.

### 2. Second Embodiment

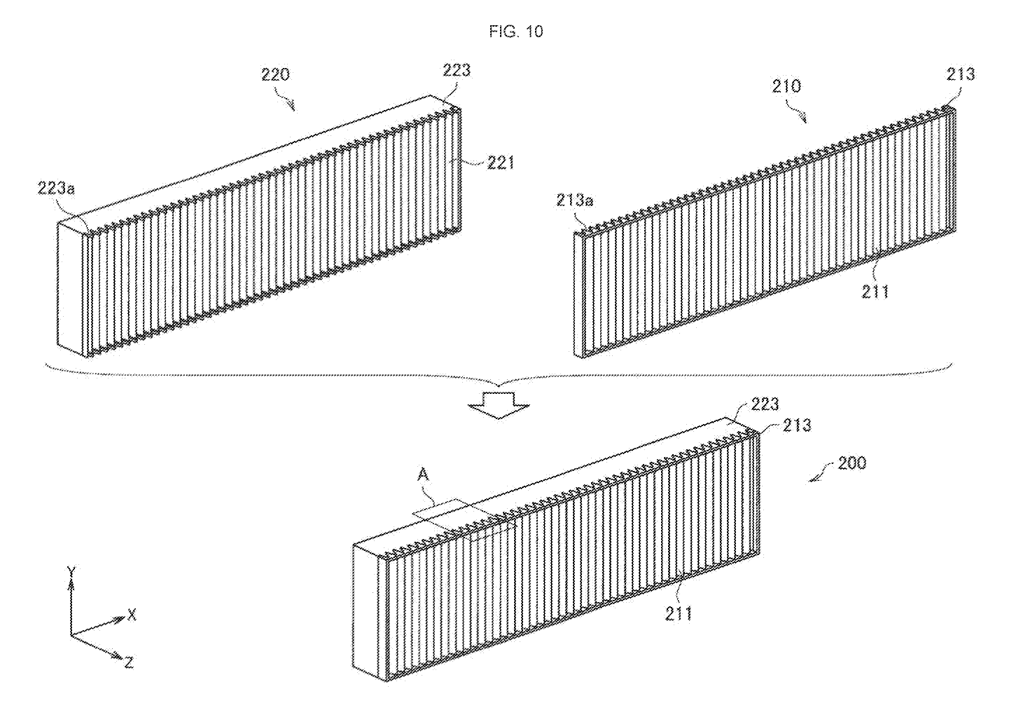

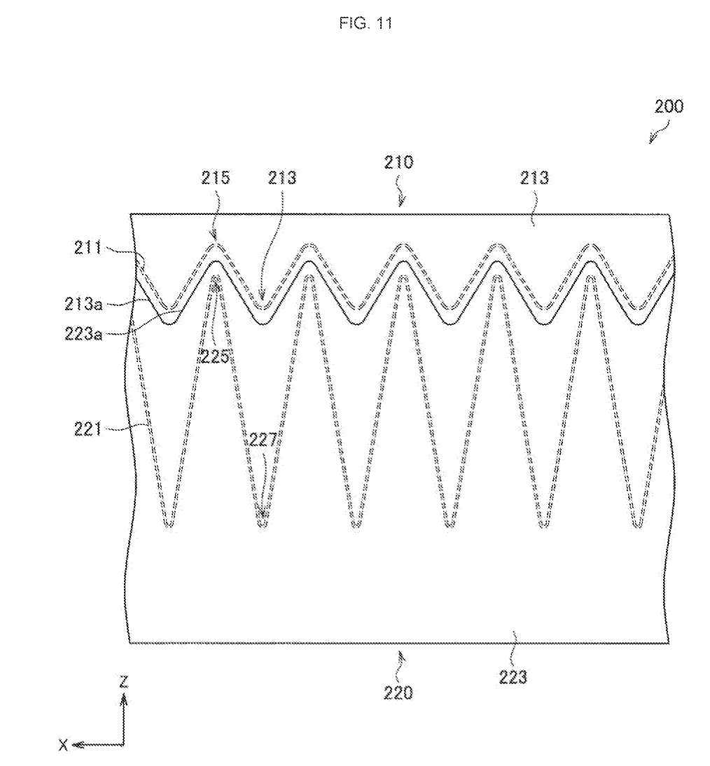

Next, on the basis of FIG. 10 and FIG. 11, a constitution of a filter structural body 200 according to the second embodiment of the present disclosure is described. With regard to the filter structural body 200 according to the present embodiment, FIG. 10 is a perspective view showing a state where the first filter section 210 and second filter section 220 are disassembled and a state where these filters are combined. FIG. 11 is a partially-enlarged top view for describing a stacking state of the filter structural body 200 according to the present embodiment, and is an enlarged view of a region A in FIG. 10. As shown in FIG. 10, the filter structural body 200 according to the present embodiment includes the first filter section 210 and second filter section 220. Similarly to the first embodiment, the filter structural body 200 according to the present embodiment is constituted as a multistage filter. However, as compared with the filter structural body 100 according to the first embodiment, it is different in a point that the first filter 211 and the second filter 221 are fixed to the respective different frames.

The first filter section 210 includes the first filter 211 and a first frame 213. The first filter 211 may be made a material and configuration similar to those of the first filter 110 according to the first embodiment. In the first filter 211, its outer periphery is fixed to the first frame 213. Each of the top face and the bottom surface of the first frame 213 is a surface along the longitudinal direction in which convex portions 215 and concave portions 217 of the first filter 211 continue repeatedly, and, on a portion opposite to the second filter section 220, formed are zigzag-shaped notches 213a corresponding to the concavity-convexity of the first filter 211.

The second filter section 220 includes the second filter 221 and a second frame 223. The second filter 221 may be made a material and configuration similar to those of the second filter 120 according to the first embodiment. In the second filter 221, its outer periphery is fixed to the second frame. Each of the top face and the bottom surface of the second frame 223 is a surface along the longitudinal direction in which convex portions 225 and concave portions 227 of the second filter 221 continue repeatedly, and, on a portion opposite to the first filter section 210, formed are notches 223a shaped so as to engage with the notches 213a of the first frame 213.

The first filter section 210 and the second filter section 220 are stacked so as to make the notches 213a and 223a formed on the respective frames 213 and 223 engage with each other, whereby one filter structural body 200 is constituted as shown in FIG. 10. In the filter structural body 200 according to the present embodiment, as shown in FIG. 11, when the first frame 213 and the second frame 223 are stacked, the first filter 211 at the former stage becomes a state of being accommodated in the second filter 221 at the latter stage. For this reason, it is preferable that the depth of the concavity-convexity of the notch 213a of the first frame 213 is made substantially the same extent as the depth of the concavity-convexity of the first filter 211. Moreover, the pitch of the concavity-convexity of the notch 213a may be made a size of substantially the same as or an integral multiple of the pitch of the first filter 211. With this, when the first frame 213 and the second frame 223 are stacked, it is possible to make easily the convex portion 215 of the first filter 211 and the convex portion 225 of the second filter 221 correspond to each other.

In this way, even in the case of having the two frames 213 and 223 like the filter structural body 200 according to the present embodiment, it is possible to make the second filter 221 with the deeper depth accommodate the first filter 211 with the shallow depth. Therefore, similarly to the filter structural body according to the first embodiment, it is possible to realize the space saving of the filter structural body 200.

As compared with the filter structural body 100 according to the first embodiment, in the filter structural body 200 according to the present embodiment, the number of parts increases. However, it becomes possible to handle the first filter section 210 and the second filter section 220 independently. Therefore, at the time of exchanging the filter structural body 200, it is possible to exchange only either one of the first filter section 210 or the second filter section 220. For example, in the case where substances that are difficult to remove with the application of a shock from the outside, such as oil or smoke, adhere to the filter, it becomes necessary to exchange the filer. In such a case, by forming the constitution of the filter structural body 200 according to the present embodiment, for example, since it is possible to exchange only the first filter section 210 being exposed to the outside where substances difficult to remove adhere easily, it is possible to reduce costs due to parts exchange. Moreover, as described in the first embodiment, the filter of an electret type is applicable to the first filter 211 and the second filter 221. However, while being low pressure loss and high collection efficiency, it is comparatively expensive. Then, by applying the filter of an electret type only to the second filter 221 with low exchange frequency, it is possible to further reduce also costs due to parts exchange.

In this connection, in FIG. 10 and FIG. 11, the configuration of the notches 213a of the first frame 213 has been made the zigzag shape. However, the present disclosure is not limited to such an example. For example, it may be made a gentle wave shape of a curved surface, or may be made a rectangular concavity-convexity. At this time, it may be sufficient that the depth of the concavity-convexity corresponds approximately to the depth of the first filter 211. It is possible to stack such that the convex portion 215 of the first filter 211 and the convex portion 225 of the second filter 221 approximately coincide with each other.

### 3. Modified Example

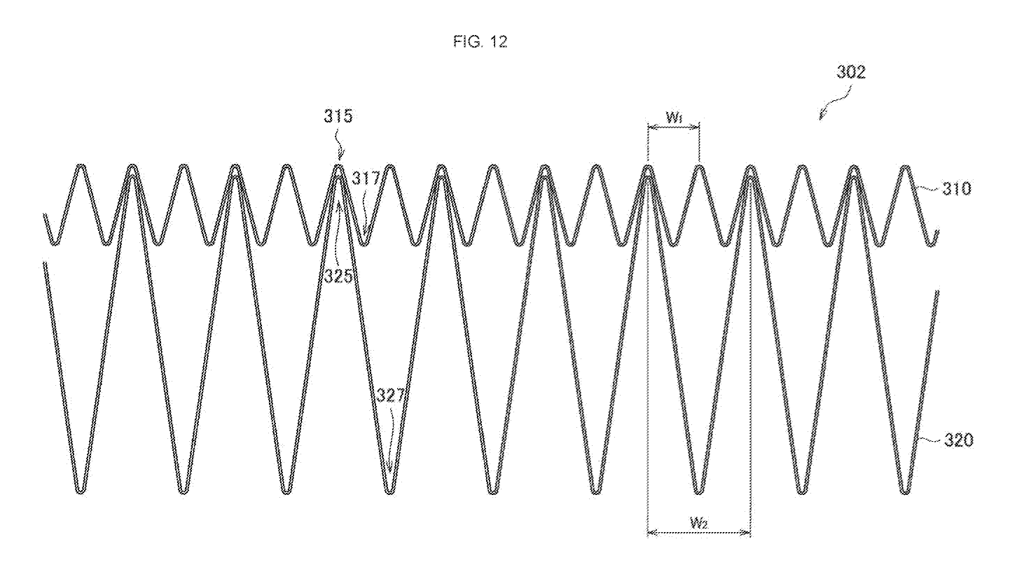

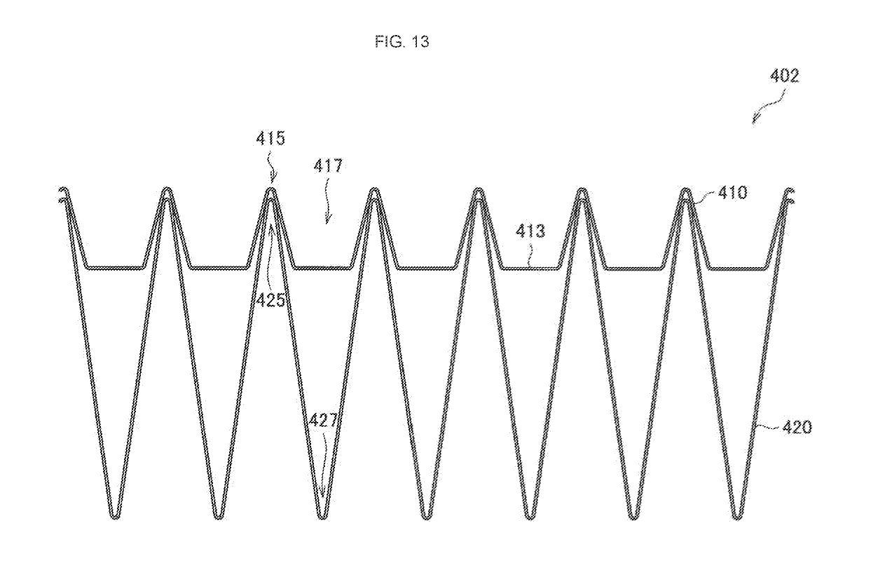

A constitution of the filter section of the filter structural body according to the present disclosure is not limited to the above-described embodiments, and for example, it may be made as shown in FIG. 12 or FIG. 13. FIG. 12 and FIG. 13 each is an explanatory illustration showing a modified example of the filter section of the filter structural body of the present disclosure.

A filter section 302 shown in FIG. 12 is constituted such that two concave portions 317 of a first filter 310 at the former stage are accommodated in a concave portion 327 of a second filter 320 at the latter stage. That is, in the first filter 310, its pitch W₁ is made one half (½) of the pitch W₂ of the second filter 320. At this time, a convex portion 315 of the first filter 310 and a convex portion 325 of the second filter 320 are made to coincide with each other. Moreover, the number of concave portions 317 of the first filter 310 to be accommodated in one concave portion 327 of the second filter 320 is not limited to two, and three or more concave portions 317 may be accommodated. In this way, by making the number of concave portions and convex portions of the first filter 310 increase, the surface area of the first filter 310 increase, and it is possible to lower pressure loss.

Moreover, a filter section 402 shown in FIG. 13 is an example in which a configuration of a first filter 410 at the former stage is deformed, and a bottom portion 413 of a concave portion 417 of the first filter 410 is made flat. Similarly to the first embodiment, a second filter 420 includes a folding structure in which convex portions 425 and concave portions 427 continue repeatedly in a zigzag shape. At this time, a convex portion 415 of the first filter 410 and a convex portion 425 of the second filter 420 are made to coincide with each other. In this way, by making the bottom portion 413 of the concave portion 417 of the first filter 410 flat, as compared with the case of making it a sharp shape as shown in the above-described embodiments and the modified example shown in FIG. 12, there is a possibility that pressure loss may increase slightly due to the reduction of the surface area. However, it becomes easy to make dust collected by the first filter 410 fall from the filter, and it is possible to increase the removability of dust.

The preferred embodiment(s) of the present disclosure has/have been described above with reference to the accompanying drawings, whilst the present disclosure is not limited to the above examples. A person skilled in the art may find examples and modifications, and it should be understood that they will naturally come under the technical scope of the present disclosure.

For example, the description has been given for the case where the filter structural body of the above-described embodiments is disposed in the projection display device. However, the present technology is not limited to such an example. For example, the filter structural body of the present disclosure is applicable to the devices of the projection display device.

Further, the effects described in this specification are merely illustrative or exemplified effects, and are not limitative. That is, with or in the place of the above effects, the technology according to the present disclosure may achieve other effects that are clear to those skilled in the art from the description of this specification.

Additionally, the present technology may also be configured as below.

(1)

A projection display device, including:

a filter structural body in which a plurality of filters each including a folding structure in which a concavity-convexity is repeated are stacked,

in which in the filter structural body,

respective convex portions of the filters are made to coincide, and between a pitch of any of the filters, one concave portion or a plurality of concave portions of another filter is or are accommodated, and

in an inside of the filter having a maximum length in a vertical direction relative to a filter surface, another filter is accommodated.

(2)

The projection display device according to (1), in which a weight per unit area of the filter at a former stage disposed on an external-portion side in the projection display device is smaller than a weight per unit area of the filter at a latter stage.

(3)

The projection display device according to (1) or (2), in which the filter at a former stage disposed on an external-portion side in the projection display device has a predetermined color.

(4)

The projection display device according to any one of (1) to (3), in which the plurality of filters are fixed to one frame.

(5)

The projection display device according to any one of (1) to (3), in which only one of the plurality of filters is fixed to a frame, and

the other filters are fixed to the filter fixed to the frame.

(6)

The projection display device according to any one of (1) to (3), in which the plurality of filters are fixed to respective different frames, and

each of the frames is provided with notches that correspond to the concavity-convexity of the filter and are shaped so as to engage when the filters have been stacked.

(7)

The projection display device according to any one of (1) to (6), in which in the filter at a former stage disposed on an external-portion side in the projection display device, a bottom surface of the concave portion is formed flat.

(8)

A filter structural body, including:

a plurality of filters each including a folding structure in which a concavity-convexity is repeated,

in which respective convex portions of the filters are made to coincide, and between a pitch of any of the filters, one concave portion or a plurality of concave portions of another filter is or are accommodated, and in an inside of the filter having a maximum length in a vertical direction relative to a filter surface, another filter is stacked so as to be accommodated.

### REFERENCE SIGNS LIST

1 projection display device
5 adhesive
10 housing
20 constituent part
30 cooling fan
100, 200 filter structural body
102, 302, 402 filter section
110, 211, 310, 410 first filter
115, 125, 215, 225, 315, 325, 415, 425 convex portion
117, 127, 217, 227, 317, 327, 417, 427 concave portion
120, 221, 320, 420 second filter
130 frame section
210 first filter section
213 first frame
220 second filter section
223 second frame
413 bottom portion

1. A projection display device, comprising:
a filter structural body in which a plurality of filters each including a folding structure in which a concavity-convexity is repeated are stacked,
wherein in the filter structural body,
respective convex portions of the filters are made to coincide, and between a pitch of any of the filters, one concave portion or a plurality of concave portions of another filter is or are accommodated, and
in an inside of the filter having a maximum length in a vertical direction relative to a filter surface, another filter is accommodated.

2. The projection display device according to claim 1, wherein a weight per unit area of the filter at a former stage disposed on an external-portion side in the projection display device is smaller than a weight per unit area of the filter at a latter stage.

3. The projection display device according to claim 1, wherein the filter at a former stage disposed on an external-portion side in the projection display device has a predetermined color.

4. The projection display device according to claim 1, wherein the plurality of filters are fixed to one frame.

5. The projection display device according to claim 1, wherein only one of the plurality of filters is fixed to a frame, and
the other filters are fixed to the filter fixed to the frame.

6. The projection display device according to claim 1, wherein the plurality of filters are fixed to respective different frames, and
each of the frames is provided with notches that correspond to the concavity-convexity of the filter and are shaped so as to engage when the filters have been stacked.

7. The projection display device according to claim 1, wherein in the filter at a former stage disposed on an external-portion side in the projection display device, a bottom surface of the concave portion is formed flat.

8. A filter structural body, comprising:
a plurality of filters each including a folding structure in which a concavity-convexity is repeated,
wherein respective convex portions of the filters are made to coincide, and between a pitch of any of the filters, one concave portion or a plurality of concave portions of another filter is or are accommodated, and in an inside of the filter having a maximum length in a vertical direction relative to a filter surface, another filter is stacked so as to be accommodated.
